(19) United States
(12) Patent Application Publication
(10) Pub. No.: US 2008/0047577 A1
(43) Pub. Date: Feb. 28, 2008

(54) Substrate Cleaning Device and Cleaning Method Thereof

(76) Inventors: Hideto Goto, Tsukuba-shi (JP); Kenji Furusawa, Yokohama-shi (JP); Satoshi Joya, Kawasaki-shi (JP); Ryuji Sotoaka, Abiko-shi (JP); Keiichi Tanaka, Kashiwa-shi (JP); Yoshiya Kimura, Katsushika-ku (JP); Tomoyuki Azuma, Arakawa-ku (JP)

Correspondence Address: SLATER & MATSIL, L.L.P., 17950 PRESTON RD, SUITE 1000, DALLAS, TX, 75252-5793, US

(21) Appl. No.: 11/849,857

(22) Filed: Sep. 4, 2007

Related U.S. Application Data
(63) Continuation of application No. PCT/JP2006/303137, filed on Feb. 22, 2006.

(30) Foreign Application Priority Data
Mar. 4, 2005 (JP) 2005-060089

(51) Int. Cl. B08B 3/12

(52) U.S. Cl. 134/1; 134/157

(57) ABSTRACT

A substrate cleaning device includes a rotating table that rotatably holds a silicon substrate. A light irradiation device is capable of irradiating at least a portion of a surface of the held silicon substrate with light. A nozzle is capable of selectively supplying at least N₂O water and a hydrofluoric acid solution onto the substrate. A control unit controls the supply of the light irradiation device and the nozzle and enables light irradiation by the light irradiation device when the N₂O water is supplied onto the silicon substrate.

This application is a continuation of co-pending International Application No. PCT/JP2006/303137, filed Feb. 22, 2006, which designated the United States and was not published in English, and which is based on Japanese Application No. 2005-060089 filed Mar. 4, 2005, both of which applications are incorporated herein by reference.

### TECHNICAL FIELD

An embodiment of the present invention relates to a substrate cleaning method, and particularly relates to a cleaning device for cleaning semiconductor substrates, glass substrates for liquid crystal panels, plasma panels, field emission, or the like, or other thin sheet-like substrates, and a cleaning processing method thereof.

### BACKGROUND

In performing processing, such as film-forming, lithography, etching, ion implantation, resist stripping, or the like, to a semiconductor silicon substrate, a cleaning process that cleans a surface of the substrate is performed. Cleaning of a silicon substrate is roughly classified into two types: batch-type and single-wafer type. The batch-type provides excellent throughput but has a disadvantage in that its footprint becomes larger when the wafer size becomes larger. By contrast, the single-wafer type, in which a substrate is processed one by one, has advantages in that its footprint can be reduced and that cleaning with uniformity can be performed even for a larger wafer. In spin cleaning, a typical example of the single-wafer type, a substrate is spun during which the substrate is held horizontally, and then a chemical solution or pure water is provided from a cleaning nozzle to clean a surface of the substrate.

Recently, for the purpose of cleaning mainly a silicon substrate, single-wafer type spin cleaning devices that also use light irradiation have been prevailing. Such devices aim to further enhance the performance of processing solutions by using light especially that has a wavelength of equal to or lower than 365 nm.

For example, PCT patent publication, WO 02/101808, discloses a cleaning in which, depending on an object of a semiconductor wafer to be cleaned, one or more types of functional water such as functional water of ozone water, alkaline ionized water, acidic ionized water is supplied onto a semiconductor wafer that is held on a spinning mechanism, and then the semiconductor wafer is irradiated with an excimer lamp as a secondary energy for a specified time period to facilitate the cleaning reaction of the functional water, and DHF (diluted hydrofluoric acid) is supplied, and the wafer is cleaned while it is spun.

Japanese patent publication, JP 2000-070885, discloses a technique to clean front and back surfaces of a substrate by supplying a cleaning solution to one surface of the substrate and irradiating the surface with ultraviolet rays, and irradiating the other surface with high frequency ultrasonic waves. As cleaning solutions, oxidizing radicals (HO., HO₂.), oxidizing species and/or ion containing oxygen (O₃, H₂O₂, O⁻, O₂⁻, O₃⁻) are disclosed.

### SUMMARY OF THE INVENTION

The cleaning devices disclosed in WO 02/101808 and JP 2000-070885 have a configuration based on a lamp, and the area the lamp occupies on a silicon substrate surface is significantly large, and furthermore, there is a need for dividing a portion that is related to the light irradiation, such as a lamp, from an atmosphere of a processing liquid, to protect the portion. Therefore, it is inevitable that the silicon substrate process chamber itself becomes larger than the process chamber of a general single-wafer spin cleaning device. In addition, due to the effect of the area the lamp occupies on the silicon substrate, a method is generally used in which, for example, the silicon substrate is immersed in a predetermined processing solution, and then it is irradiated with light. Therefore, at present, it is impossible to perform concurrently both immersion and irradiation on a silicon substrate.

However, in such a situation, there are some concerns that the processing solution on the silicon substrate surface may sometimes dry out, and in a worst scenario, may lead to generation of a watermark, and adversely affect the semiconductor device. In addition, depending on the size or specification of the lamp, electrical power usage used for the lamp may increase, which may undermine its cost advantage.

On the other hand, in the cleaning processing that uses light irradiation, it is important to calculate the optimum light amount, and the distance between the silicon substrate that is the object to be cleaned and the lamp, is an important factor. As disclosed in WO 02/101808

, a physical means for deciding the distance, that is, a stopper such as a protrusion or the like, is provided for positioning of the lamp. This physical means is excellent for keeping the position of the lamp at a specified height; however, there is an issue of the complication in mounting the lamp, and the fear of the breakdown of the stopper itself. Especially in the latter case, there are risks of damaging the lamp itself, and in a worst case, damaging the silicon substrate.

In addition, the cleaning solution used for substrate cleaning is generally a combination of ozone water or a hydrogen peroxide solution and hydrofluoric acid. However, in the case where ozone water or a hydrogen peroxide solution is used, the waste liquid thereof may lead to destruction of nature, and the waste liquid is not adequate for environmental conservation at all. Therefore, it is required to process the waste liquid of the ozone water or hydrogen peroxide solution, which requires high cost.

Considering the issues described above, and as a result of intensive studies for addressing issues regarding single-wafer cleaning technologies disclosed so far that use light irradiation, the inventors have found a novel cleaning technique, especially focusing on a light irradiation mechanism to be mounted in a single-wafer cleaning device and on a cleaning processing solution. Therefore, an embodiment of the present invention is to provide a novel single-wafer substrate cleaning device and a cleaning method thereof that give consideration to space-saving, low-cost and the environment.

A substrate cleaning device according to an embodiment of the present invention comprises a substrate holding means that holds a substrate, a substrate rotating means that rotates the held substrate, a light irradiation means that is capable of irradiating at least a portion of a surface on the held substrate, a supplying means that is capable of selectively supplying at least one of N₂O water and a hydrofluoric acid solution onto the substrate, and a controlling means that is capable of controlling the light irradiation means and the supplying means such that light can be irradiated by the light irradiation means when N₂O water is supplied onto the substrate. The N₂O water is a water solution in which nitrous oxide gas is dissolved in water, and is dissociated into nitrogen molecules and oxygen atoms by the irradiation of light such as ultraviolet rays, and the actions of the oxygen atoms cause oxidizing properties. When the light irradiation is stopped, the N₂O water becomes a stable state, and has functions similar to those of water.

A substrate cleaning method according to an embodiment of the present invention comprises the step of holding a substrate on a rotating table and rotating the substrate, the step of supplying N₂O water onto a surface of the rotated substrate and irradiating the substrate surface with ultraviolet rays, and the step of supplying a hydrofluoric acid solution onto the substrate surface after the irradiation of ultraviolet rays.

Properties of N₂O water used in an embodiment of the present invention are now described. FIG. 10 is a result of an experiment showing changes in the concentration of nitrous oxide when N₂O water is irradiated with ultraviolet rays. The horizontal axis shows wavelength bands in a measurement range of 200 to 340 nm, and the vertical axis shows absorbance. Curves C1 to C3 show the absorbance of N₂O; C3 shows a case of irradiation for 3 minutes, C2 shows irradiation for 1 minute, and C1 shows without irradiation. As obvious from the graph, with the light having a wavelength of equal to or greater than 240 nm, absorbance is zero and no light is absorbed. In other words, dissociation of the N₂O is not performed by the irradiation of light energy.

FIG. 11 is a table showing changes in N₂O concentration calculated from absorbance when irradiated with the light having a wavelength of 205 nm. Assuming that the concentration when irradiation time is zero is the saturating concentration (the value when the water temperature is 25 degrees centigrade), the N₂O concentrations are calculated by multiplying the concentration with the irradiation for 0 minutes by relative values of each absorbance, respectively. It can be found that, irradiation for 3 minutes, the concentration of nitrous oxide is considerably reduced. In addition, from the experiment result shown in FIG. 10, a by-product of ozone (O₃) is not detected substantially.

FIG. 12 is a schematic view of an oxidizing device that performs oxidation of a silicon wafer. The oxidizing device comprises a container P, a low-pressure mercury lamp Q disposed immediately above the container P. The low-pressure mercury lamp Q generates light that includes a wavelength of equal to or less than 240 nm, and its output is 110 W. Preferably, the low-pressure mercury lamp Q is disposed as close as possible to the container P to irradiate the entire surface of the container P.

The container P comprises a side surface and a bottom surface, and its upper surface is open, and may be formed of Teflon (registered trademark), for example. On the bottom surface of the container P, protrusions having a specified height are formed, and the back surface of a silicon wafer W is supported by the protrusions. The N₂O water filled in the container P contains about 0.1% (1068 ppm) of N₂O. After the silicon wafer W is disposed in the container P, N₂O water is filled in the container P to such an extent that the entire silicon wafer W is sufficiently immersed. In this example, as a silicon wafer to be oxidized, a silicon wafer is used after the oxide existing on its surface is previously removed with a hydrogen fluoride water solution.

FIG. 13 is a graph showing a result of a silicon wafer oxidized by the oxidizing device of FIG. 12, and shows the relation of light irradiation time in the horizontal axis and the thickness (A) of the oxidized film generated on the silicon wafer surface in the horizontal axis. The thickness of the oxidized film is obtained from Si2p spectrum waveform analysis by X-ray Photoelectron Spectroscopy (XPS). This method is described in, for example, Japan Analyst, vol. 40(1991) pp. 691-696, “Thickness determination of thin oxide layers on metal surfaces using X-ray photoelectron spectroscopy” by Kazuaki Okuda, Akio Itoh. From the graph in FIG. 13, it is observed that an oxidized film having about 6 Å is generated by light irradiation for 1 minute, and an oxidized film having about 10 Å is generated by the light irradiation for 3 minutes.

FIG. 14 is a graph showing the relation between light irradiation time and the thickness of the oxidized film generated on the surface of the silicon wafer when a silicon wafer W is oxidized by the oxidizing device shown in FIG. 12 using the water in which helium (He) is dissolved. For comparison with the nitrous oxide dissolving water, the helium is forced to be dissolved in water to exclude air constituents (such as N₂, O₂, CO₂) that are already dissolved in the water to be used. As obvious from the graph in FIG. 14, it is observed that the generated oxidized film is about 1 Å by the irradiation for 1 minute, and only about 2 Å even by irradiation for 3 minutes. In comparison with FIG. 13, it is observed that, by irradiating the nitrous oxide in water with light, an oxidized film is effectively generated on the surface of the silicon wafer W that contacts the water.

All of the oxidation of the silicon wafer described above (FIG. 13 and FIG. 14) is performed at room temperature (around 24 degrees centigrade). In addition, the oxidation described above, a low-pressure mercury lamp is used as a light source to dissociate the nitrous oxide; however, a light source other than the low-pressure mercury lamp can be used, if it can generate the light having a wavelength of equal to or less than 240 nm. In addition, the lamp output can be changed as desired, and oxidative degradation can be performed by a lamp output other than 110 W. In general, if the same lamp is used, the speed of oxidative degradation may be affected by the amount of the output. The less the output is, the speed of oxidative degradation becomes lower; to the contrary, the larger the output is, the speed of oxidative degradation becomes higher. It is possible to choose the output depending on a desired oxidative degradation speed.

FIG. 15 is a graph showing behavior of an oxidized film of a silicon wafer W when a water solution in which various gases are dissolved is used in the oxidizing device of FIG. 12. The horizontal axis is irradiation time (minute) of ultraviolet rays, and the vertical axis is oxidized film thickness (Å). As a light source, an ozone-less type high-pressure mercury lamp is used.

In the graph, G1 is a solution in which N₂O is dissolved, and G2 is that of O₂, G3 is that of air, G4 is that of He, G5 is that of N₂, and G6 is that of Ar, respectively. As obvious also from this graph, it can be found that N₂O water has a significantly higher oxidation rate than other solution water. More specifically, growth in the case of N₂O by the irradiation for 1 minute is 6 Å, that of O₂ is 3 Å, that of air is 2 Å, and those of He, N₂, Ar are 1 to 2 Å.

One of the reasons why the curve of the oxidation rate decreases along with irradiation time is thought to be the reduction in concentration of oxidizing active species that exist in water. Accordingly, it is contemplated that the reduction in the oxidation rate can be prevented by injecting unused nitrous oxide into the container so that the concentration of oxidizing active species in water does not decrease.

According to an embodiment of the present invention, by performing the cleaning of a substrate with a combinational use of at least N₂O water and a hydrofluoric acid solution, it becomes possible to eliminate the processing of waste liquid after used for cleaning, and thus a smaller and lower-cost substrate cleaning device can be achieved, and furthermore, substrate cleaning processing can be performed giving consideration to the environment.

### BRIEF DESCRIPTION OF THE DRAWINGS

FIG. 1 is a perspective view illustrating an external configuration of a substrate processing device according to an embodiment of the present invention, showing that a light irradiation device is in a waiting state;

FIG. 2 illustrates a cross sectional configuration of a light irradiation device;

FIG. 3A and FIG. 3B, shown collectively as FIG. 3, where FIG. 3A shows that a light irradiation device is in a waiting position, and FIG. 3B shows that a light irradiation device is in a cleaning processing position;

FIG. 4A and FIG. 4B, shown collectively as FIG. 4, where FIG. 4A is a plan view illustrating oscillation of a light irradiation device, and FIG. 4B is a side view thereof,

FIG. 5 is a block diagram illustrating a configuration of a control unit;

FIG. 6 is a flow chart showing a cleaning sequence of this embodiment;

FIG. 7 is a flow chart showing another cleaning sequence of this embodiment;

FIG. 8 illustrates an example in which a chamber is mounted above a rotating table;

FIG. 9A and FIG. 9B, shown collectively as FIG. 9, where FIG. 9A and FIG. 9B illustrate another moving mechanism of a light irradiation device;

FIG. 10 is a graph showing changes in N₂O concentration in water by the irradiation of an ozone-less type high-pressure mercury lamp;

FIG. 11 is a table showing changes in N₂O concentration calculated from absorbance for a wavelength of 205 nm;

FIG. 12 is a schematic view of an oxidizing device when an oxidizing experiment of a silicon wafer is conducted;

FIG. 13 is a graph showing a result of the oxidizing experiment of the silicon wafer by the experiment device of FIG. 12;

FIG. 14 is a graph showing a result of an oxidizing experiment of a silicon wafer by the experiment device of FIG. 12 when the water in which helium (He) is dissolved is used; and

FIG. 15 is a graph showing behavior of silicon oxidation in various gases dissolving water by the irradiation of an ozone-less type high-pressure mercury lamp.

### DETAILED DESCRIPTION OF ILLUSTRATIVE EMBODIMENTS

Preferred embodiments of the present invention will be now described in detail, referring to the accompanying drawings.

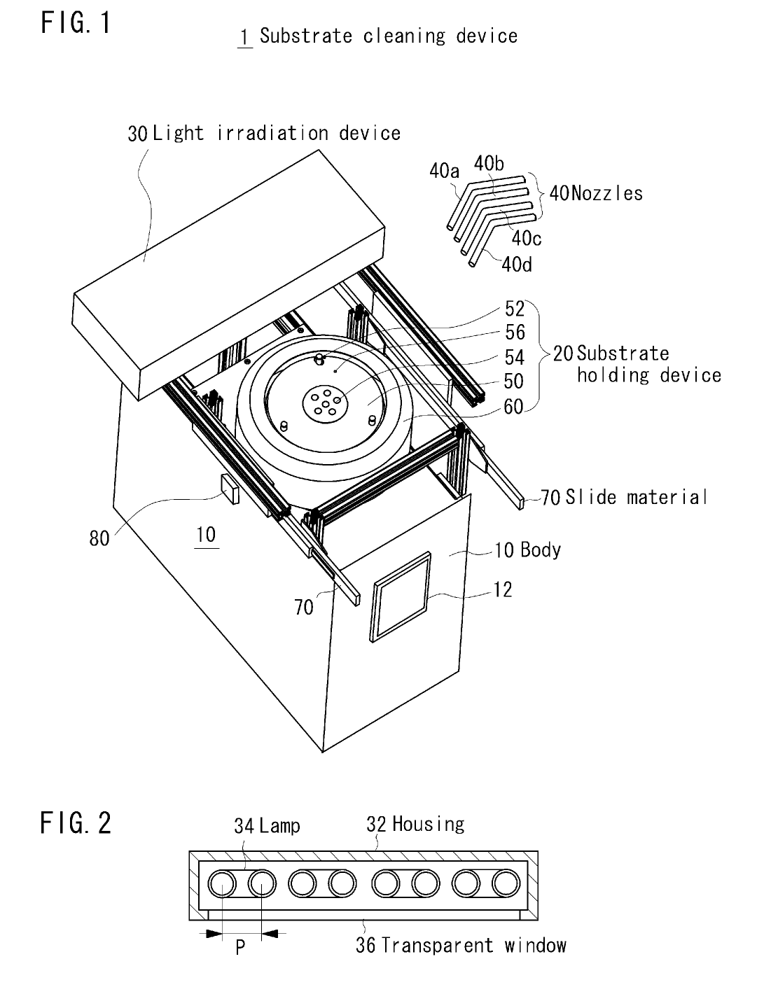

FIG. 1 is a perspective view showing an external view of a single-wafer type substrate cleaning device according to an embodiment of the present invention. A substrate cleaning device 1 comprises a body 10, a substrate holding device 20 mounted in the body 10, a light irradiation device 30 disposed above the substrate holding device 20, and a plurality of nozzles 40 for supplying a chemical solution or the like required for cleaning. In addition, in the body 10, as described later, a control unit is mounted for controlling operations of the substrate holding device 20, the light irradiation device 30 and the nozzles 40.

On the front surface of the body 10, a touch-sensitive display 12 is mounted for inputting an instruction from a user. The user may select a desired cleaning process sequence or provide a necessary input instruction through the touch-sensitive display 12. The touch-sensitive display 12 may also indicate what the status of the cleaning processing of the substrate cleaning device 1 is.

The substrate holding device 20 comprises a rotating table 50 for rotatably holding a silicon substrate, and a collecting pot 60 disposed to surround the rotating table 50. The rotating table 50 is coupled to a motor that is not shown. On the upper surface of the rotating table 50, a plurality of holding tools 52 are mounted for holding an edge of the silicon substrate. In a center portion of the rotating table 50, a plurality of blow-off outlets 54 are formed for blowing off gas. By blowing off nitrogen gas from the blow-off outlets 54 of the rotating table 50, the silicon substrate can be held above the rotating table 50 in a non-contact manner. This uses the Bernoulli theorem or a theorem of air bearing.

By rotating the rotating table 50, the silicon substrate held in a non-contact manner can be rotated with its outer periphery being guided by the holding tools 52. In addition, on the rotating table 50, a substrate detecting sensor 56 is provided to detect the placement of the silicon substrate, and the result of the detection is outputted to the control unit. The detecting sensor 56 may detect the presence or absence of a silicon substrate, for example, by detecting reflection light of infrared rays or the like.

On the body 10, a slide material 70 is mounted. The light irradiation device 30 is mounted on the slide material 70, and the light irradiation device 30 may be moved by a driving mechanism, which is not shown, in a horizontal direction on the slide material 70. On the slide material 70, a position detecting sensor 80 is mounted for detecting the light irradiation device 30, and the result of the detection is outputted to the control unit.

The nozzles 40 comprise a plurality of nozzles 40a to 40d. Each of the nozzles 40a to 40d may be positioned in a grouped position, or may be positioned in a distant position. Each of the nozzles 40a to 40d is connected to a supply source of a solution or gas, and provides the solution or gas therefrom. In addition, each of the nozzles 40a to 40d may be moved by a moving mechanism, which is not shown, to above the rotating table 50, or getting away from above the rotating table 50. For example, the nozzle 40a may provide a solution that includes N₂O, and the nozzle 40b may provide a hydrofluoric acid water solution, and the nozzle 40c may provide pure water or rinse water, and the nozzle 40d may provide an inert gas such as nitrogen.

Alternatively, a single nozzle may be capable of providing a plurality of processing solutions. For example, the nozzle 40a may provide N₂O water, or provide ultra pure water. In such a case, the supply source coupled to the nozzle 40a can be switched.

FIG. 2 illustrates a cross sectional configuration of a light irradiation device 30. The light irradiation device 30 comprises a rectangular housing 32 and a lamp tube 34 in the housing 32. In the housing 32, the lamp tube 34 folded at a lamp pitch P is housed. In addition, on the lower surface of the housing 32, a transparent window 36 is mounted so that light from the lamp tube 34 may be emitted from the transparent window 36. For the lamp, a mercury lamp or the like that includes ultraviolet rays having a wavelength of equal to or less than 240 nm, for example, may be used. The transparent window 36 may be made of silica glass, for example. More preferably, on the inner wall of the housing 32, a reflective film or the like may be coated such that the light from the lamp may be effectively emitted through the transparent window 36.

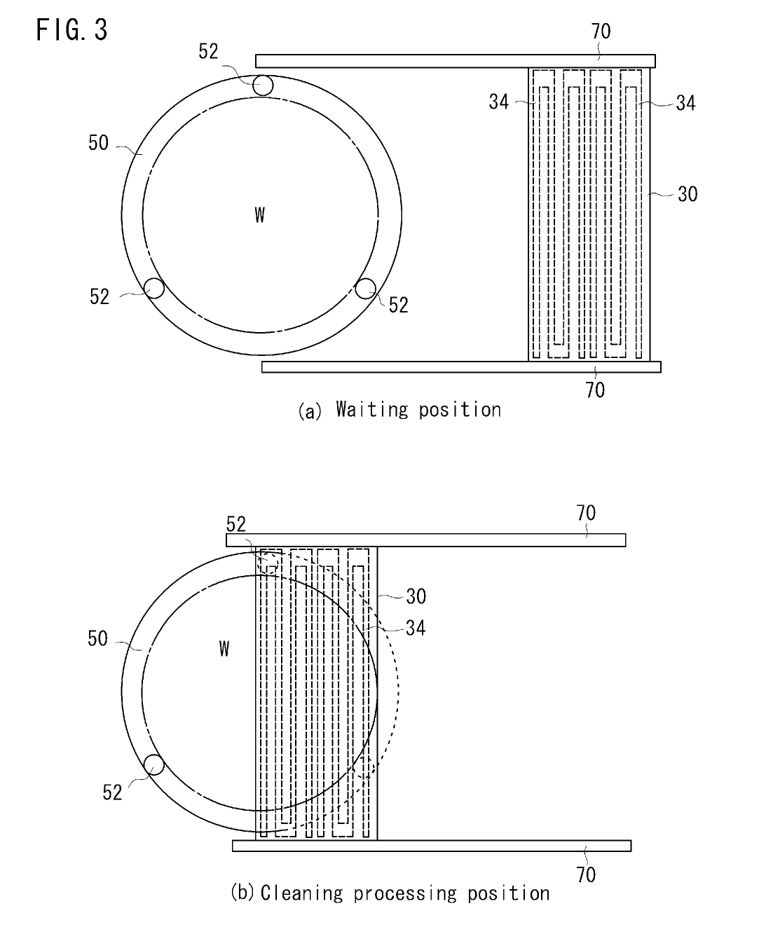

When a silicon substrate W is transferred to the rotating table 50, the light irradiation device 30 is in a waiting position as shown in FIG. 3A so that it does not obstruct the transfer. When cleaning processing is performed, the light irradiation device 30 is moved to a cleaning processing position by means of the slide material 70 as shown in FIG. 3B. At this time, the light irradiation device 30 covers at least half of the area of the rotating table 50, and is at a distance equal to or less than about 30 mm, and preferably equal to or less than 25 mm, from the surface of the rotating table 50.

The area a lamp occupies is one of the most important elemental technologies in the cleaning that uses the light irradiation in which light amount is an important factor, and thus the lamp area has caused various adverse effects as described in the problems of conventional technology. Therefore, in this embodiment, to improve the conventional problems, at least half of the rotating table 50 is obtained as the minimum area required for the light irradiation area. This can significantly reduce the area the light irradiation requires, in other words, a footprint of the lamp, compared to the case where all the area of the rotating table 50, that is, all the area of the silicon substrate, is used for the light irradiation area. On the other hand, the reduced area can be used for a space in which the nozzles 40 are disposed such that a processing solution can be supplied onto the silicon substrate from the nozzles 40, and at the same time, the silicon substrate can be irradiated with light. Accordingly, generation of a watermark due to the dryness of the processing solution can be prevented.

In addition, the light irradiation device 30 can be oscillated on the slide material 70 in directions S at a specified period, when cleaning processing is performed. When the lamp tube 34 is arranged at a lamp pitch P as shown in FIG. 2, the oscillating distance is preferably equal to or greater than the pitch P. With the lamp pitch P, there is a high probability that lamp irradiation cannot be performed to the area in which the lamp tube 34 does not physically exist. Therefore, by oscillating the light irradiation device 30 in accordance with the lamp pitch P, the area that is not irradiated by the lamp can be eliminated, and the silicon substrate W can be irradiated with uniform light.

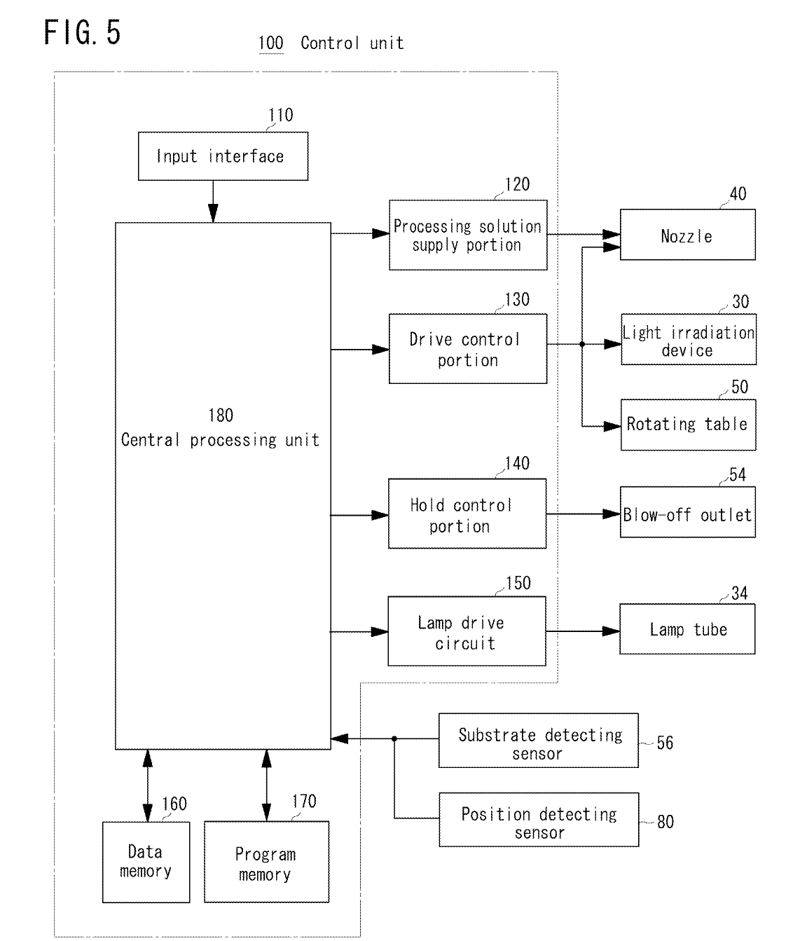

FIG. 5 is a block diagram illustrating an electrical configuration of a control unit 100 in the body 10. A control unit 100 comprises an input interface 110 for receiving an input from the touch-sensitive display 12, a processing solution supply portion 120 for controlling the supply of a processing solution from the nozzle 40, a drive control portion 130 for controlling, for example, the driving of movement of the light irradiation device 30, movement of the nozzle 40, and rotation of the rotating table 50, a hold control portion 140 for controlling, for example, the supply of nitrogen gas from the blow-off outlets 54 of the rotating table 50, a lamp drive circuit 150 for controlling on and off of the light irradiation device 30 and the lamp tube 34, a data memory 160 for storing a result from the substrate detecting sensor 56 and the position detecting sensor 80 or other data or the like, a program memory 170 for storing a program to control a cleaning process sequence, and a central processing unit 180 for controlling each portion depending on the program.

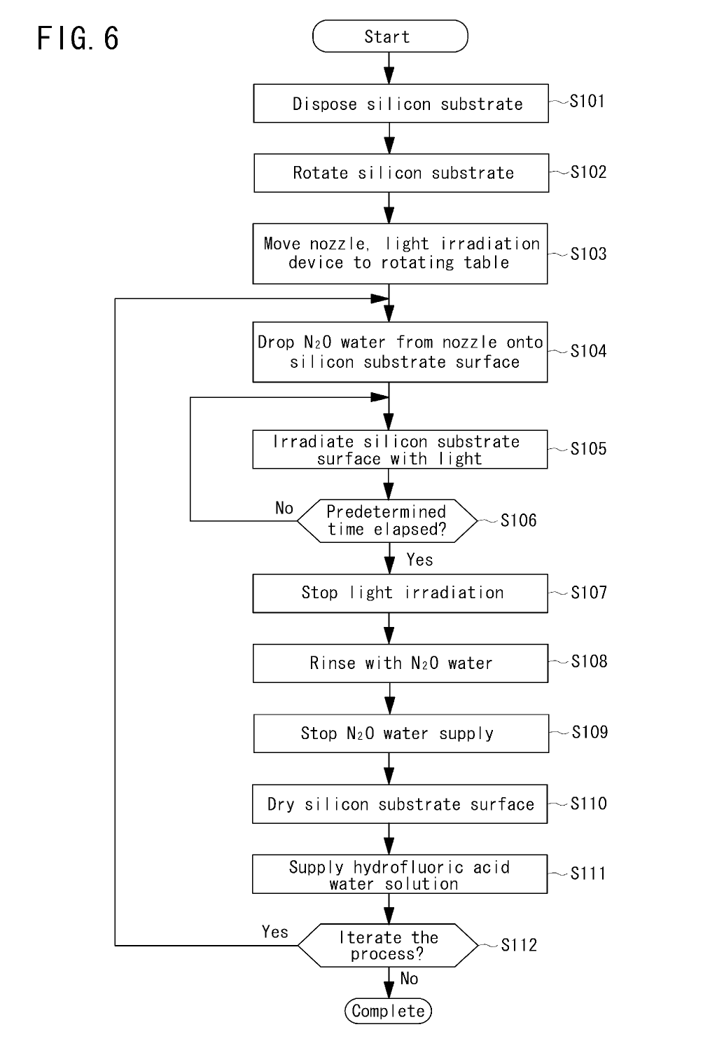

Referring now to FIG. 6, a cleaning sequence in a substrate cleaning device according to this embodiment will be described. A silicon substrate W is disposed on the rotating table 50 in a state where the light irradiation device 30 is positioned in a waiting position as shown in FIG. 3A (step S101). At this time, nitrogen gas is blown off from the blow-off outlets 54 of the rotating table 50, and the silicon substrate W is held above the rotating table 50 in a non-contact manner. The movement of the silicon substrate W can be performed by a wafer transfer arm, for example.

When the silicon substrate W is disposed above the rotating table 50, the disposition is detected by the substrate detecting sensor 56. In response to the disposition of the silicon substrate W, the central processing unit 180 makes the rotating table 50 rotate at a specified speed, via the drive control portion 130. The silicon substrate W is rotated above the rotating table 50 in a non-contact manner with the outer periphery of the substrate W being guided by the holding tools 52 (step S102).

The central processing unit 180 makes the nozzle 40 move from the waiting position to above the rotating table 50, via the drive control portion 130, and move the light irradiation device 30 to a cleaning processing position (step S103). The movements of the nozzle 40 and the light irradiation device 30, and the rotation of the rotating table 50 may be performed in reverse order.

Then, the central processing unit 180 makes the processing solution supply portion 120 drop N₂O water from the nozzle 40a onto the substrate surface (step S104). If the object to be cleaned has a hydrophobic surface such as a silicon substrate, it is required to supply the processing solution for all over the silicon substrate. Therefore, for example, when the inner diameter of a processing solution outlet of the nozzle is about 5 mm and the supply amount of the processing solution is 1 liter per minute, it is desirable that the processing solution outlet of the nozzle is positioned at a distance equal to or less than 30 mm, and preferably 25 mm, from the center of the substrate, assuming that the distance from the outlet to the silicon substrate is about 20 mm. This condition is same in a case where light irradiation is not performed.

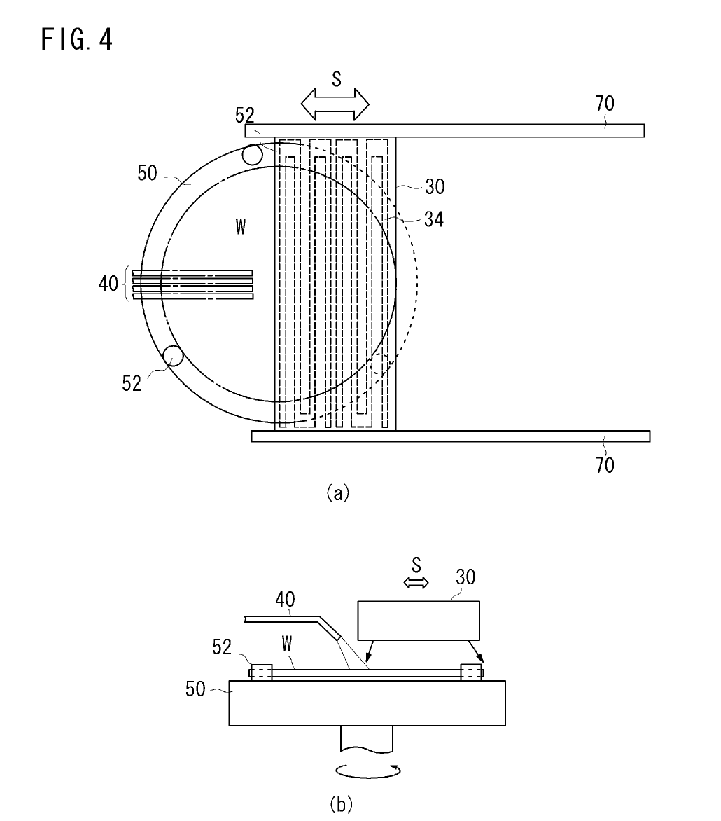

Next, the central processing unit 180 makes the lamp tube 34 irradiate the substrate surface with light, via the lamp drive circuit 150 (step S105). At this time, the light irradiation device 30 is placed in a cleaning processing position, and covers at least half the area of the rotating table 50, and the nozzle 40 is placed in a vacant area (see FIG. 4). As such, it is possible to concurrently perform N₂O water supply and light irradiation toward the surface of the silicon substrate W. In addition, in a case where the switching of the lamp between on and off requires time, the lamp may be switched on in advance, and the light irradiation device 30 may be moved to a cleaning processing position with the lamp being on status. In this case, to avoid ultraviolet rays from leaking through the transparent window 36 to outside during the movement and thus causing ozone, a shutter may be provided to the transparent window 36 such that the shutter closes during the movement and the shutter opens when the light irradiation device 30 reaches the cleaning processing position.

More preferably, the central processing unit 180 may provide nitrogen gas from the nozzle 40d through the processing solution supply portion 120, and make the silicon substrate surface be in an inert gas atmosphere. This is preferable because it can prevent ozone caused by the ultraviolet rays irradiated from the lamp from escaping in the air. In addition, the central processing unit 180 may oscillate the light irradiation device 30 in directions S at a specified period, as shown in FIG. 4.

To the surface of the rotated silicon substrate W, N₂O water is sequentially supplied from the nozzle 40a, and the N₂O water is activated on the substrate surface by the irradiation with ultraviolet rays, and the silicon substrate surface is modified. The area irradiated with light by the light irradiation device 30 is at least half of the silicon substrate W, however, because the silicon substrate W is rotated, the N₂O water on the entire surface of the silicon substrate W is uniformly irradiated with the light. In addition, by oscillating the light irradiation device 30, nonuniformity in light intensity due to the lamp pitch can be prevented, and more uniform light irradiation can be performed.

The N₂O water supplied onto the silicon substrate surface is collected in the collecting pot 60, and discharged or reused. It is to be noted here that N₂O water is harmless substantially similarly to water, if it is not irradiated with light. In other words, in a status light irradiation is not performed, N₂O water is not activated and is nothing but a water solution. Accordingly, specific processing is not necessarily required in discharging the N₂O water after it is used.

The central processing unit 180 monitors whether or not light irradiation is performed for a time period required for cleaning (step S106). The light irradiation time may be determined in advance. The central processing unit 180 makes the light irradiation stop when the light irradiation continues for a predetermined time (step S107). The stop of the light irradiation may be done by switching off the lamp tube 34, or, in a case a shutter is provided to the transparent window 36, by closing the shutter.

After the light irradiation is stopped, N₂O water is supplied onto the silicon substrate surface for a predetermined time period from the nozzle 40a (step S108). At this time, the light irradiation is not performed, and thus the N₂O water is not activated and the N₂O water acts as rinse water.

After rinsing by the N₂O water is finished, the supply of N₂O water from the nozzle 40a is stopped (step S109), and then the central processing unit 180 makes the silicon substrate W rapidly spin, via the drive control portion 130, to remove the N₂O water from the substrate surface and dry the substrate surface (step S110). At this time, the supply of nitrogen gas from the nozzle 40d continues, and the silicon substrate surface is protected in a status being isolated from the air.

Then, the central processing unit 180 makes the supply of the nitrogen gas from the nozzle 40d stop, and makes a hydrofluoric acid water solution be supplied from the nozzle 40b (step S111). The hydrofluoric acid may be diluted hydrofluoric acid. By the supply of the hydrofluoric acid, the silicon substrate surface is cleaned. After cleaning by the hydrofluoric acid water solution, rinsing with N₂O water or pure water may be performed if desired, or the steps of the N₂O water supply and the light irradiation may be performed repeatedly (step S112).

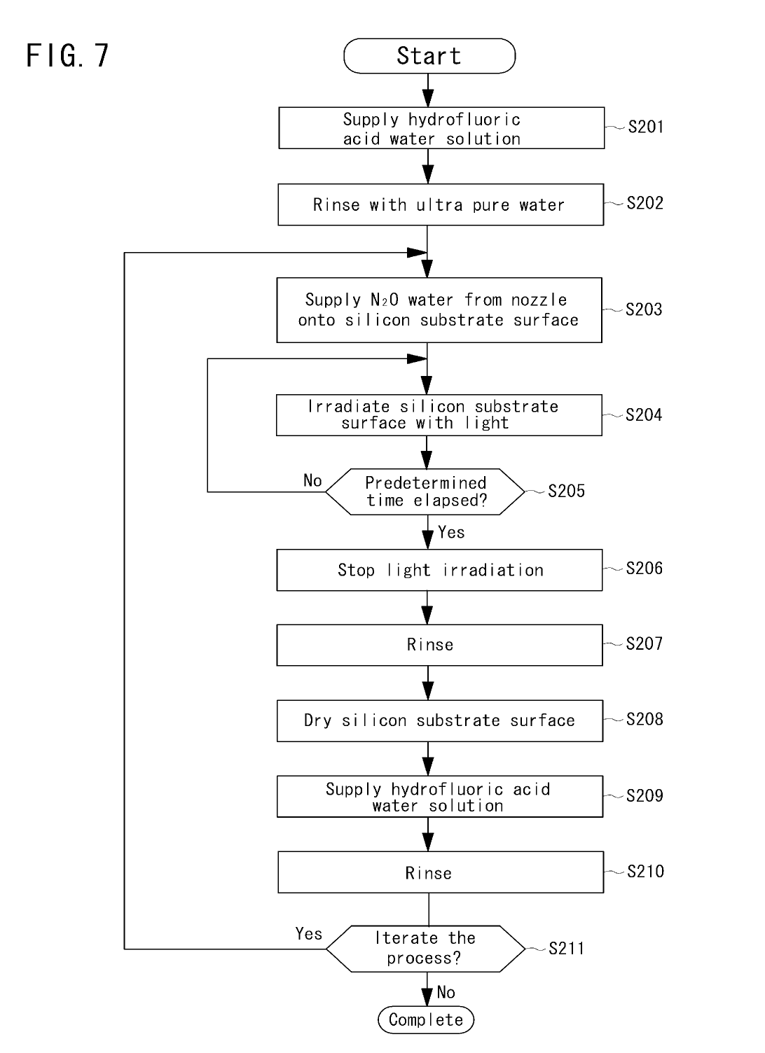

FIG. 7 illustrates another example of a cleaning process sequence. From step S101 to step S103 described in FIG. 6 are common, and thus these steps are deleted from FIG. 7 and the description herein is omitted. [00661 To the silicon substrate surface held above the rotating table 50, a hydrofluoric acid water solution is supplied from the nozzle 40b (step S201). By this process, the silicon substrate surface is cleaned. Then, N₂O water is supplied from the nozzle 40a onto the silicon substrate surface, or ultra pure water is supplied from the nozzle 40c, to perform rinsing (step S202). After that, N₂O water is supplied from the nozzle 40a onto the silicon substrate surface (step S203), and the silicon substrate surface is irradiated with light (step S204). After the light irradiation is continued for a predetermined time (step S205), the light irradiation is stopped (step S206).

Then, rinsing by N₂O water or ultra pure water is performed (step S207). After the rinse is finished, the silicon substrate surface is dried (step S208). The drying may be performed by rapidly spinning the substrate, or supplying a heated inert gas from the nozzle 40d. Next, a hydrofluoric acid water solution is supplied (step S209), and then rinsing by ultra pure water or the like is performed (step S210). The steps described above may be iterated if desired (step S211).

In the cleaning process sequences described above (FIG. 6 and FIG. 7), the N₂O water is dropped and irradiated with ultraviolet rays during which the silicon substrate is rotated. This is because the growth of an oxidized film on the silicon substrate surface in the case where the silicon substrate is rotated becomes about 30% higher than the case with the silicon substrate being stopped. This higher growth can improve throughput in the cleaning processing. However, it is not necessarily required to rotate the silicon substrate, and N₂O water may be dropped and irradiated with ultraviolet rays in a state where the substrate is stopped.

Moreover, in a cleaning process sequence, an oxidized film may remain on the silicon substrate surface. In this case, N₂O water may be dropped onto the silicon substrate, and the process may be completed in a status where the substrate is irradiated with ultraviolet rays, or rinsing may be performed thereafter and then completed. For example, in a subsequent step, it may be advantageous in a case where a thick film oxidized layer is formed on the silicon substrate surface, because the growth of a natural oxidation film can be prevented.

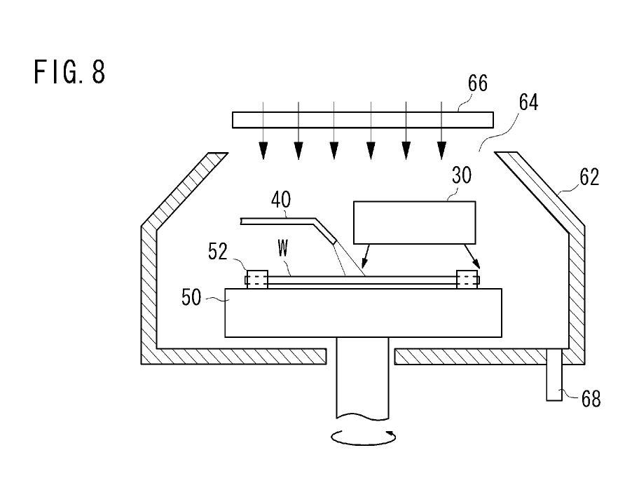

Other embodiments of the present invention will now be described. FIG. 8 is an example in which a chamber 62 is mounted such that it surrounds the rotating table 50. The chamber 62 substantially surrounds the surrounding of the rotating table 50, and an opening 64 is formed thereof. To the opening 64, an ultra filter 66 is provided for supplying an inert gas by downblow. The ultra filter 66 can be moved by a mechanism, which is not shown, in a vertical direction or in a horizontal direction. In the chamber 62, a drain groove 68 is formed, and the processing solution and inert gas or the like used for the processing are collected through the drain groove 68.

The chamber 62 is filled with an inert gas, such as nitrogen, in a space that surrounds the silicon substrate W during the cleaning processing of the silicon substrate W. This process prevents the silicon substrate W from contacting the air, and prevents ozone generation due to the light irradiation of the light irradiation device 30.

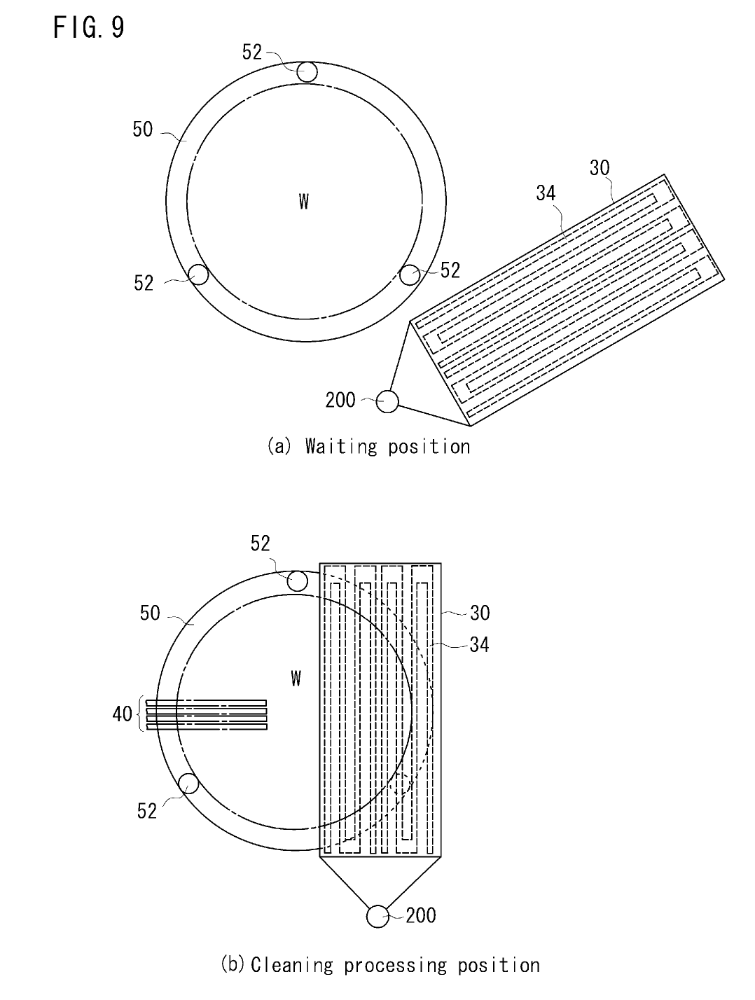

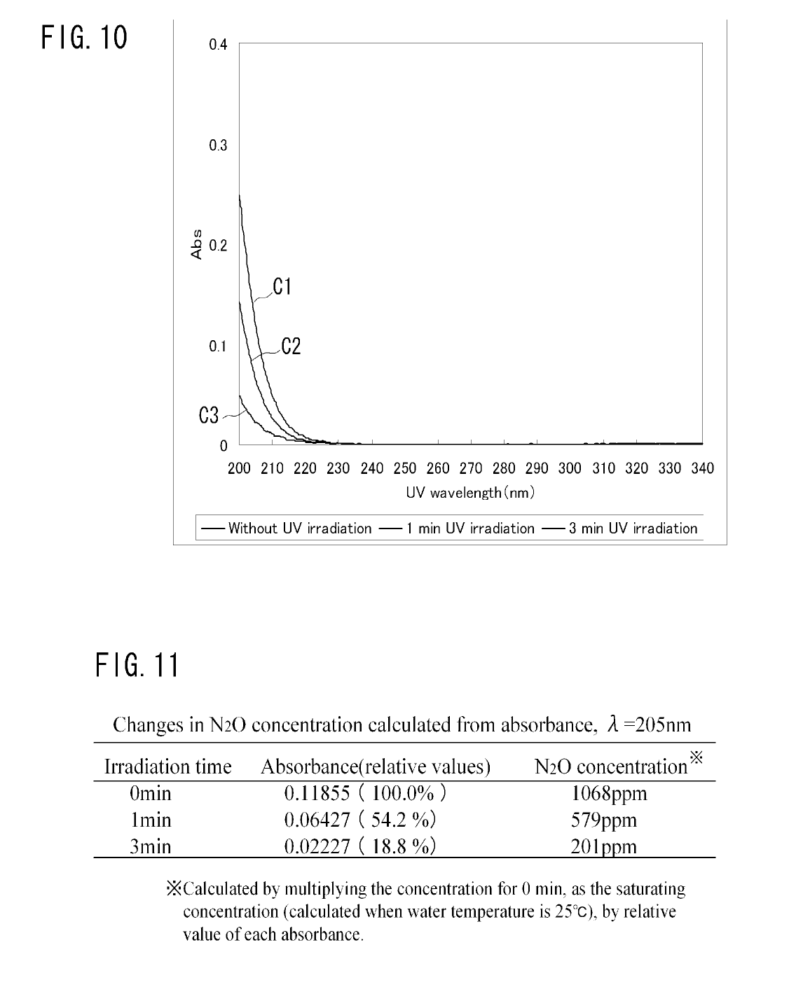

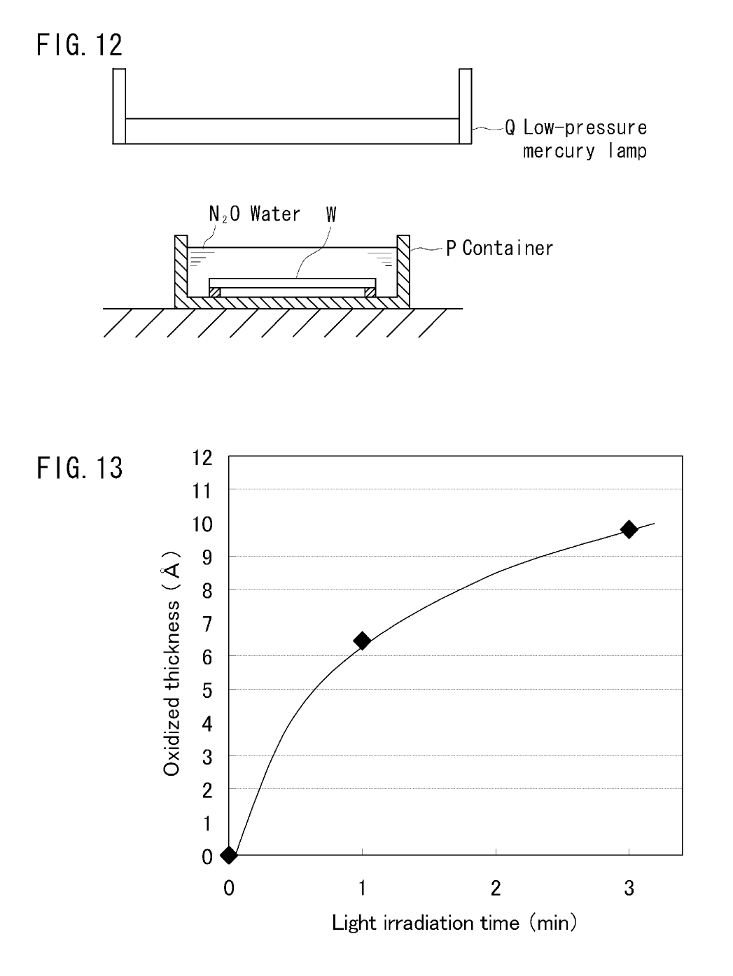

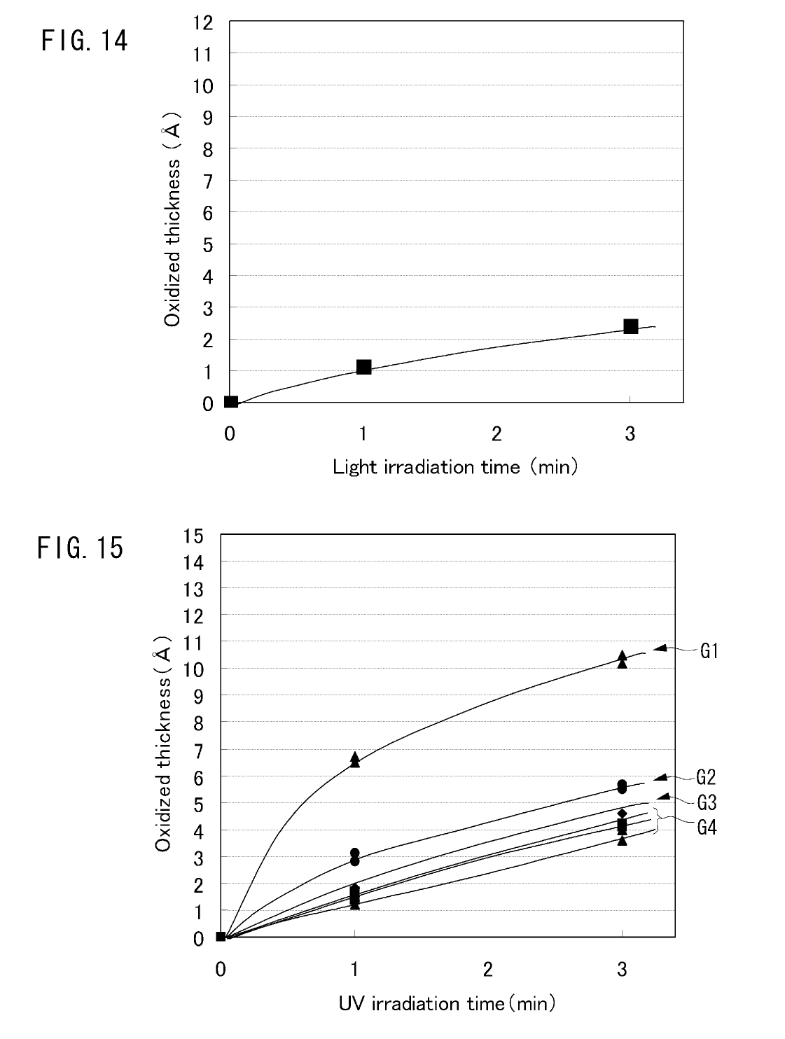

In the embodiment described above, an example is shown in which the light irradiation device 30 is moved horizontally via the slide material 70; however, other than this example, a light irradiation device 30 may be rotated as shown in FIG. 9A and FIG. 9B. As shown in FIG. 9A and FIG. 9B, an edge portion of the light irradiation device 30 may be mounted on a rotary shaft 200 of a motor such that the light irradiation device 30 can be rotated. FIG. 9A illustrates a state that the light irradiation device 30 is in a waiting position, and FIG. 9B illustrates a state that the light irradiation device 30 is in a cleaning processing position. In addition, the light irradiation device 30 may be oscillated using the rotary shaft 200 as a fulcrum, during the cleaning processing.

By performing cleaning processings described above, metal impurities or particles or the like on the silicon substrate surface can be removed. In addition, by making the area irradiated with light, by the light irradiation device 30, a portion of the silicon substrate surface, light irradiation can be performed during which a cleaning solution is supplied onto the silicon substrate surface. Moreover, a footprint of the light irradiation device can be reduced, and thus a smaller substrate cleaning device and cost reduction can be achieved. In addition, conventional cleaning of silicon substrates have been performed generally with a combination of ozone water or a hydrogen peroxide solution and a hydrofluoric acid water solution, that requires processing of waste liquid of the ozone water or hydrogen peroxide solution, and with a risk of adverse effects on the environment. The combination of N₂O water and a hydrofluoric acid water solution does not substantially require processing of waste liquid of the N₂O water, and in addition there is an advantage that the waste liquid can be reused.

While preferred embodiments of the present invention have been described in detail, the present invention is not limited to such specific embodiments, and various changes and modifications can be made within the scope of the invention set forth in the appended claims.

For example, in the embodiments described above, the light irradiation device 30 is capable of being moved in a horizontal direction, or rotated by a rotary shaft; however in addition, the light irradiation device 30 may be moved in a vertical direction (in a direction approaching or moving away from the rotating table). For example, positioning in a vertical direction of the light irradiation device may be performed by using a stepping motor or the like, and the light irradiation device may be positioned closer to the silicon substrate above the rotating table.

The silicon substrate is held in a non-contact manner by blowing off nitrogen gas from the blow-off outlets 54 of the rotating table 50; however, a backside cleaning of the silicon substrate can be performed by spraying pure water, hydrofluoric acid water solution, N₂O water from a blow-off outlet 54. In this case, it is preferable that a plurality of the blow-off outlets 54 are formed in the rotating table 50, and nitrogen gas is supplied from a predetermined blow-off outlet 54, during which pure water, hydrofluoric acid water solution, N₂O water is selectively supplied from other blow-off outlet 54.

In addition, in the embodiments described above, the silicon substrate cleaning with the combination of N₂O water and a hydrofluoric acid water solution is described; however, a cleaning step using other cleaning solutions can be added to the cleaning steps using these cleaning solutions.

A substrate cleaning device and a cleaning method according to an embodiment of the present invention can be used in a single-wafer type cleaning process of a thin substrate such as a silicon semiconductor substrate, a compound semiconductor substrate, a liquid crystal glass, plasma panel, or the like.

What is claimed is:

1. A substrate cleaning device comprising:
a substrate holder to hold a substrate;
a substrate rotator that rotates the held substrate;
a light irradiation source that is capable of irradiating at least a portion of a surface of the held substrate;
a supply source configured to selectively supply water in which nitrous oxide gas is dissolved (hereafter referred to as N₂O water) and a hydrofluoric acid solution onto the substrate; and
a controller adapted to control the light irradiation source and the supplying source such that light can be irradiated by the light irradiation source when the N₂O water is supplied onto the substrate.

2. The substrate cleaning device according to claim 1, wherein the controller causes the light irradiation source to irradiate light during the time the N₂O water is supplied onto the substrate.

3. The substrate cleaning device according to claim 1, wherein the controller causes the supply source to supply the N₂O water onto the substrate for a predetermined period after the light irradiation by the light irradiation source is stopped.

4. The substrate cleaning device according to claim 1, wherein the controller causes the supply source to supply a hydrofluoric acid solution onto the substrate after supplying the N₂O water.

5. The substrate cleaning device according to claim 1, wherein the controller causes the light irradiation source to oscillate.

6. The substrate cleaning device according to claim 1, wherein the controller causes the substrate rotator to rotate the substrate when the N₂O water is supplied onto the substrate.

7. The substrate cleaning device according to claim 1, wherein the controller causes the N₂O water to be supplied when the substrate rotator is stopped.

8. The substrate cleaning device according to claim 1, wherein the controller comprises a memory and the memory comprises a program that controls a cleaning process sequence.

9. The substrate cleaning device according to claim 1, wherein the light irradiation source is capable of moving between a waiting position and a cleaning processing position, the light irradiation source covering at least a portion of the substrate holder when the light irradiation source is in the cleaning processing position.

10. The substrate cleaning device according to claim 9, wherein the supply source is positioned above the substrate holder that is not covered by the light irradiation source when the light irradiation source is in the cleaning processing position.

11. The substrate cleaning device according to claim 1, wherein the light irradiation source comprises a shutter for passing or interrupting light of a lamp.

12. The substrate cleaning device according to claim 1, wherein the light irradiation source comprises a lamp that emits ultraviolet rays.

13. The substrate cleaning device according to claim 1, wherein the supplying source comprises a plurality of nozzles disposed in a plurality of positions, the N₂O water being supplied onto the substrate through a selected nozzle of the plurality of nozzles.

14. The substrate cleaning device according to claim 1, further comprising a chamber that encloses the substrate holder and a filter that supplies an inert gas into the chamber, the inert gas being supplied into the chamber when a surface of the substrate is irradiated with light.

15. The substrate cleaning device according to claim 1, wherein the substrate comprises a silicon substrate.

16. A substrate cleaning method comprising:
holding a substrate above a substrate holder;
supplying N₂O water onto a surface of the substrate, and simultaneously irradiating the surface of the substrate with light that comprises at least ultraviolet rays; and
supplying a hydrofluoric acid solution onto the surface of the substrate, after the irradiation with the ultraviolet rays.

17. The substrate cleaning method according to claim 16, further comprising rotating a substrate, wherein the N₂O water is supplied onto the surface of the rotated substrate.

18. The substrate cleaning method according to claim 17, wherein the hydrofluoric acid solution is supplied onto the surface of the substrate after irradiating with the ultraviolet rays.

19. The substrate cleaning method according to claim 17, wherein the hydrofluoric acid solution is supplied onto the surface of the rotated substrate before supplying N₂O water.

20. The substrate cleaning method according to claim 17, wherein rotating the substrate comprises holding the substrate over a rotating table, the rotating table holding the substrate by Bernoulli or air bearing forces.

21. The substrate cleaning method according to claim 16, further comprising supplying an inert gas onto the surface of the substrate during the irradiation with the ultraviolet rays.

22. The substrate cleaning method according to claim 16, further comprising supplying rinse water after supplying the hydrofluoric acid solution.

23. The substrate cleaning method according to claim 22, wherein the rinse water comprises N₂O water that is not irradiated with light.

24. The substrate cleaning method according to claim 22, wherein the rinse water comprises ultra pure water.

25. The substrate cleaning method according to claim 16, further comprising drying the surface of the substrate by rotating the substrate.

26. The substrate cleaning method according to claim 25, wherein drying the surface of the substrate comprises supplying an inert gas onto the surface of the substrate.

27. The substrate cleaning method according to claim 26, wherein supplying the inert gas comprises supplying a heated inert gas.

28. The substrate cleaning method according to claim 16, wherein the substrate comprises a silicon substrate.
